(19) United States
(12) Patent Application Publication
(10) Pub. No.: US 2006/0022904 A1
(43) Pub. Date: Feb. 2, 2006

(54) Plasma display apparatus applying sustain pulse and driving method thereof

(75) Inventors: Jong Woon Kwak, Dongan-gu (KR); Tae Hyung Kim, Seoul (KR); Seong Hak Moon, Seoul (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/191,269

(22) Filed: Jul. 28, 2005

(30) Foreign Application Priority Data
Jul. 29, 2004 (KR) 10-2004-0059920
Sep. 8, 2004 (KR) 10-2004-0071914

(51) Int. Cl. G09G 3/28

(52) U.S. Cl. 345/60

(57) ABSTRACT

A plasma display apparatus and a driving method thereof in accordance with the present invention is characterized in that a scan electrode is alternately applied with a positive voltage and a negative voltage, and a sustain electrode is alternately applied with the opposite voltages to the voltages applied to the scan electrode. In accordance with the present invention, since a sustain process is performed with relatively low voltage, it is possible to reduce production cost, heat generation and power consumption.

This nonprovisional application claims priority under 35 U.S.C. § 119(a) on Patent Application Nos. 2004-0059920, 2004-0071914 filed in Korea on Jul. 29, 2004, Sep. 8, 2004, the entire contents of which are hereby incorporated by reference.

### BACKGROUND OF THE INVENTION

1. Field of the Invention

The present invention relates to a plasma display apparatus, and more particularly, to a plasma display apparatus for performing a sustain process and a driving method thereof.

2. Description of the Background Art

FIG. 1 is a view for explaining a driving method of a conventional plasma display apparatus. Referring to FIG. 1, in order to drive a plasma display panel using subfields, a frame period (16.7 ms) is divided into n subfields and each subfield is divided into a reset period, an address period, and a sustain period. In FIG. 1, the number of subfields is eight and a reset period and an address period are shown as a single period. In order to display a gray-level, different weights are assigned to the respective sustain periods of the subfields and a gray-level is represented by an appropriate combination of the subfields.

Meanwhile, the plasma display apparatus alternately applies a sustain pulse to scan electrodes and sustain electrodes in order to maintain the discharge of selected cells during sustain period. A sustain driving apparatus for applying a sustain pulse is shown in FIG. 2.

FIG. 2 is a circuit diagram of a conventional plasma display apparatus for applying a sustain pulse. FIG. 3 shows waveform diagrams illustrating a voltage and current that is applied to scan electrodes by the conventional plasma display apparatus.

Referring to FIG. 2, the conventional plasma display apparatus includes energy recovery units 10 and 20 for recovering reactive power and electrode drivers 15 and 25 for applying a sustain voltage Vₛ to a scan electrode Y and a sustain electrode Z.

Now, a driving method of the energy recovery unit 10 and the electrode driver 15 with respect to the scan electrode Y will be described with reference to FIG. 3.

First, in a first state State 1, a first switch Q1 is turned on and second through fourth switches Q2, Q3, and Q4 are turned off. Thus, energy stored in a capacitor C1 is supplied to a panel, so that the voltage Vₚ of the panel rises. In the first state State 1, as shown in FIG. 3, since energy is supplied from the capacitor C1 to the panel, current flowing through an inductor L1 is forward current (+I_{L}).

In a second state State 2, the first switch Q1 and the second switch Q2 are turned on and the third switch Q3 and the fourth switch Q4 are turned off. Thus, the voltage Vₚ becomes a sustain voltage Vₛ. When the first state State 1 is terminated, that is, when the voltage Vₚ reaches the maximum voltage Vₛ due to LC resonance at a time t1, the voltage Vₛ is applied to the panel.

Then, in a third state State 3, the third switch Q3 is turned on, and the first switch Q1, the second switch Q2, and the fourth switch Q4 are turned off. Accordingly, energy stored in the panel is collected in the capacitor C1 and the voltage Vₚ falls. In the third state State 3, as shown in FIG. 3, since current flows from the panel to the capacitor C1, current flowing through the inductor L1 is backward current (−I_{L}).

In a fourth state State 4, the third switch Q3 and the fourth switch Q4 are turned on and the first switch Q1 and the second switch Q2 are turned off. Accordingly, the voltage Vp becomes a ground voltage. When the third state State 3 is terminated, that is, at a time t2, the voltage Vp is maintained at the ground voltage.

As such, while the energy recovery unit 10 and the electrode driver 15 operate with respect to the scan electrode Y, a seventh switch Q7 remains turned-on and thus the sustain electrode Z is maintained at the ground voltage.

Also, the operation of the energy recovery unit 20 and the electrode driver 25 with respect to the sustain electrode Z are similar to that of the energy recovery unit 10 and the electrode driver 15 as described above. Likewise, while the energy recovery unit 20 and the electrode driver 25 operate with respect to the sustain electrode Z, the fourth switch Q4 remains turned-on and thus the scan electrode Y is maintained at the ground voltage.

As described above, in the conventional plasma display apparatus, since a high sustain voltage Vₛ of 180-210 Volts is applied to the scan electrode Y and sustain electrode Z, expensive switching devices having a high withstand voltage characteristic should be used.

As a result, the conventional plasma display apparatus requires high manufacturing costs due to such expensive switching devices.

Further, in the conventional plasma display apparatus, since a high-frequency sustain pulse is applied using a high sustain voltage, heat generation and power consumption increase due to resistance components.

### SUMMARY OF THE INVENTION

Accordingly, an object of the present invention is to solve at least the problems and disadvantages of the background art.

The present invention provides a plasma display apparatus and a driving method thereof, which are capable of maintaining a discharge by applying a voltage lower than a sustain voltage to scan electrodes and sustain electrodes.

According to an aspect of the present invention, there is provided a plasma display apparatus including: a plasma display panel including a scan electrode and a sustain electrode; and an electrode driver alternately applying a fourth negative voltage and a third positive voltage to the sustain electrode whenever a first positive voltage and a second negative voltage are alternately applied to the scan electrode, in a sustain period.

According to another aspect of the present invention, there is provided a plasma display apparatus including: a plasma display panel including a scan electrode and a sustain electrode; a scan electrode driver alternately applying a first positive voltage and a second negative voltage to the scan electrode in a sustain period; and a sustain electrode driver applying a third positive voltage to the sustain electrode when the scan electrode driver applies the second negative voltage, and applying a fourth negative voltage to the sustain electrode when the scan electrode driver applies the first positive voltage, in the sustain period.

According to another aspect of the present invention, there is provided a driving method of a plasma display apparatus, including: alternately applying a first positive voltage and a second negative voltage to a scan electrode; and alternately applying a fourth negative voltage and a third positive voltage to the sustain electrode whenever the first positive voltage and the second negative voltage are alternately applied.

In the plasma display apparatus and the driving method thereof, according to the present invention, since a discharge is maintained by the potential difference between a scan electrode and a sustain electrode, switching devices having a low withstand voltage characteristic can be used.

As a result, the plasma display apparatus according to the present invention has an advantage of minimizing manufacturing costs through use of switching devices having a low withstand voltage characteristic.

Further, the plasma display apparatus and the driving method thereof, according to the present invention, have an advantage of reducing heat generation and power consumption caused by resistance components, since a discharge is maintained by the potential difference between scan electrodes and a sustain electrodes.

### BRIEF DESCRIPTION OF THE DRAWINGS

The invention will be described in detail with reference to the following drawings in which like numerals refer to like elements.

FIG. 1 is a view for explaining a driving method of a conventional plasma display panel.

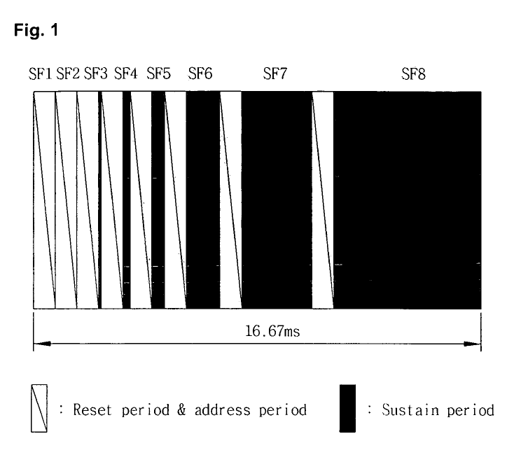

FIG. 2 is a circuit diagram of a conventional plasma display apparatus for applying a sustain pulse.

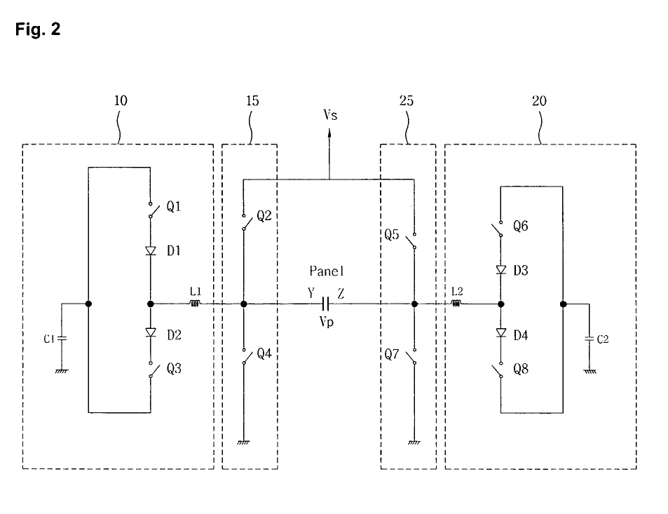

FIG. 3 shows waveform diagrams illustrating a voltage and current that is applied to scan electrodes by the conventional plasma display apparatus.

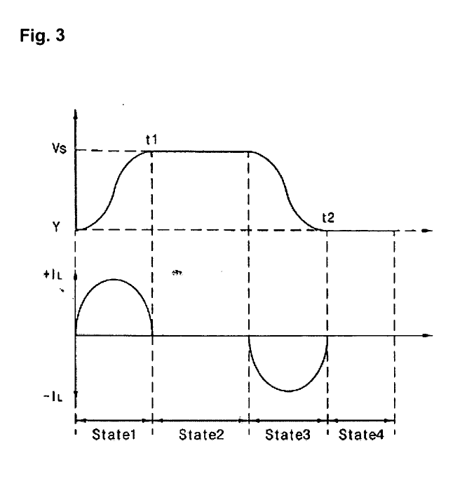

FIG. 4 is a block diagram of a plasma display apparatus according to the present invention.

FIG. 5 is a circuit diagram of a plasma display apparatus according to a first embodiment of the present invention.

FIG. 6 shows switching timing diagrams and sustain pulse waveform diagrams which are implemented by the plasma display apparatus according to the first embodiment of the present invention.

FIG. 7 is a circuit diagram of a plasma display apparatus according to a second embodiment of the present invention.

FIG. 8 is a circuit diagram of a plasma display apparatus according to a third embodiment of the present invention.

FIG. 9 shows switching timing diagrams and sustain pulse waveform diagrams which are implemented by the plasma display apparatus according to the third embodiment of the present invention.

FIG. 10 is a circuit diagram of a plasma display apparatus according to a fourth embodiment of the present invention.

FIG. 11 shows switching timing diagrams and sustain pulse waveform diagrams which are implemented by the plasma display apparatus according to the fourth embodiment of the present invention.

FIG. 12 shows waveform diagrams of current flowing through an inductor of the plasma display apparatus according to the fourth embodiment of the present invention.

FIG. 13 is a circuit diagram of a plasma display apparatus according to a fifth embodiment of the present invention.

FIG. 14 is a circuit diagram of a plasma display apparatus according to a sixth embodiment of the present invention.

FIG. 15 shows switching timing diagrams and sustain pulse waveform diagrams which are implemented by the plasma display apparatus according to the sixth embodiment of the present invention.

### DETAILED DESCRIPTION OF PREFERRED EMBODIMENTS

Preferred embodiments of the present invention will be described in a more detailed manner with reference to the drawings.

According to an aspect of the present invention, there is provided a plasma display apparatus including: a plasma display panel including a scan electrode and a sustain electrode; and an electrode driver alternately applying a fourth negative voltage and a third positive voltage to the sustain electrode whenever a first positive voltage and a second negative voltage are alternately applied to the scan electrode, in a sustain period.

The electrode driver alternately applies, to the sustain electrode, a negative voltage corresponding to (1-n) times (0<n<1, n is a real number) of a value obtained by adding the absolute value of the first voltage with the absolute value of the fourth voltage and a positive voltage corresponding to m times (0<m<1, m is a real number) of a value obtained by adding the absolute value of the second voltage with the absolute value of the third voltage, whenever alternately applying, to the scan electrode, a positive voltage corresponding to n times of a value obtained by adding the absolute value of the first voltage with the absolute value of the fourth voltage and a negative voltage corresponding to (1-m) times of a value obtained by adding the absolute value of the second voltage with the absolute value of the third voltage.

The electrode driver alternately applies, to the sustain electrode, a negative voltage corresponding to 0.5 times of a value obtained by adding the absolute value of the first voltage with the absolute value of the fourth voltage and a positive voltage corresponding to 0.5 times of a value obtained by adding the absolute value of the second voltage with the absolute value of the third voltage, whenever alternately applying, to the scan electrode, a positive voltage corresponding to 0.5 times of a value obtained by adding the absolute value of the first voltage with the absolute value of the fourth voltage and a negative voltage corresponding to 0.5 times of a value obtained by adding the absolute value of the second voltage with the absolute value of the third voltage.

The electrode driver includes: (a) a scan electrode driver alternately applying the first positive voltage and the second negative voltage to the scan electrode in the sustain period; and (b) a sustain electrode driver applying the third positive voltage to the sustain electrode when the scan electrode driver applies the second negative voltage, and applying the fourth negative voltage to the sustain electrode when the scan electrode driver applies the first positive voltage, in the sustain period.

The scan electrode driver includes a positive scan electrode driver for applying the first positive voltage and a negative scan electrode driver for applying the second negative voltage, and the sustain electrode driver includes a positive sustain electrode driver for applying the third positive voltage when the negative scan electrode driver applies the second negative voltage and a negative sustain electrode driver for applying the fourth negative voltage when the positive scan electrode driver applies the first negative voltage.

The positive scan electrode driver includes a first switch having one end connected to a first supply voltage for supplying the first positive voltage and the other end connected to the scan electrode, and a second switch having one end connected to the scan electrode and the other end connected to a ground. The negative scan electrode driver includes a third switch having one end connected to a second supply voltage for supplying the second negative voltage and the other end connected to the scan electrode, and a fourth switch having one end connected to the scan electrode and the other end connected to the ground. The positive sustain electrode driver includes a fifth switch having one end connected to a third supply voltage for supplying the third positive voltage and the other end connected to the sustain electrode, and a sixth switch having one end connected to the sustain electrode and the other end connected to the ground. The negative sustain electrode driver includes a seventh switch having one end connected to a fourth supply voltage for supplying the fourth negative voltage and the other end connected to the sustain electrode, and an eighth switch having one end connected to the sustain electrode and the other end connected to the ground.

The positive scan electrode driver further includes a first diode having an anode terminal connected to the other end of the second switch and a cathode terminal connected to one end of the second switch, and a first short prevention diode having an anode terminal connected to the scan electrode and a cathode terminal connected to one end of the second switch. The negative scan electrode driver further includes a second diode having an anode terminal connected to one end of the fourth switch and a cathode terminal connected to the other end of the fourth switch, and a second short prevention diode having a cathode terminal connected to the scan electrode and an anode terminal connected to one end of the fourth switch. The positive sustain electrode driver further includes a third diode having a cathode terminal connected to one end of the sixth switch and an anode terminal connected to the other end of the sixth switch, and a third short prevention diode having an anode terminal connected to the sustain electrode and a cathode terminal connected to one end of the sixth switch. The negative sustain electrode driver further includes a fourth diode having an anode terminal connected to one end of the eighth switch and a cathode terminal connected to the other end of the eighth switch, and a fourth short prevention diode having a cathode terminal connected to the sustain electrode and an anode terminal connected to one end of the fourth switch.

The first short prevention diode and the second short prevention diode are fast recovery diodes.

At least one of the first short prevention diode, the second short prevention diode, the third short prevention diode, or the fourth short prevention diode is a fast recovery diode.

The positive scan electrode driver further includes a first path selection unit for disconnecting the scan electrode from the positive scan electrode driver when the negative scan electrode driver operates. The negative scan electrode driver further includes a second path selection unit for disconnecting the scan electrode from the negative scan electrode driver when the positive scan electrode driver operates.

The first path selection unit includes a first path selection switch having one end connected to the scan electrode and the other end connected to one end of the second switch, and the second path selection unit includes a second path selection switch having one end connected to the scan electrode and the other end connected to one end of the fourth switch.

The positive sustain electrode driver further includes a third path selection unit for disconnecting the sustain electrode from the positive sustain electrode driver when the negative sustain electrode driver operates, and the negative sustain electrode driver further includes a fourth path selection unit for disconnecting the sustain electrode from the negative sustain electrode driver when the positive sustain electrode driver operates.

The third path selection unit includes a third path selection switch having one end connected to the sustain electrode and the other end connected to one end of the sixth switch, and the fourth path selection unit includes a fourth path selection switch having one end connected to the sustain electrode and the other end connected to one end of the eighth switch.

The scan electrode driver further includes: (a) a first scan electrode energy recovery unit for supplying energy corresponding to 0.5 times of the first positive voltage to the scan electrode using resonance, and collecting energy corresponding to 0.5 times of the first positive voltage using resonance after the positive scan electrode driver applies the first positive voltage to the scan electrode; and (b) a second scan electrode energy recovery unit for supplying energy corresponding to 0.5 times of the second negative voltage to the scan electrode using resonance, and collecting energy corresponding to 0.5 times of the second negative voltage using resonance after the negative scan electrode driver applies the second negative voltage to the scan electrode. The sustain electrode driver further includes: (c) a third sustain electrode energy recovery unit for supplying energy corresponding to 0.5 times of the third positive voltage to the sustain electrode using resonance when the second scan electrode energy recovery unit supplies the energy, and collecting energy corresponding to 0.5 times of the third positive voltage using resonance after the positive sustain electrode driver applies the third positive voltage to the sustain electrode; and (d) a fourth sustain electrode energy recovery unit for supplying energy corresponding to 0.5 times of the fourth negative voltage to the sustain electrode using resonance when the first scan electrode energy recovery unit supplies the energy, and collecting energy corresponding to 0.5 times of the fourth negative voltage using resonance after the negative sustain electrode driver applies the fourth negative voltage to the sustain electrode.

The positive scan electrode driver further includes a fifth short prevention diode for blocking the second voltage from being applied to the ground when the second voltage is applied after the second scan electrode energy recovery unit supplies the energy. The negative scan electrode driver further includes a sixth short prevention diode for blocking the first voltage from being applied to the ground when the first voltage is applied after the first scan electrode energy recovery unit supplies the energy. The positive sustain electrode driver further includes a seventh short prevention diode for blocking the fourth voltage form being applied to the ground when the fourth voltage is applied after the fourth scan electrode energy recovery unit supplies the energy. The negative sustain electrode driver further includes an eighth short prevention diode for blocking the third voltage from being applied to the ground when the third voltage is applied after the third scan electrode energy recovery unit supplies the energy.

The positive scan electrode driver further includes a fifth path selection unit for disconnecting the scan electrode from the positive scan electrode driver when the negative scan electrode driver or the second scan electrode energy recovery unit operates. The negative scan electrode driver further includes a sixth path selection unit for disconnecting the scan electrode from the negative scan electrode driver when the positive scan electrode driver or the first scan electrode energy recovery unit operates. The positive sustain electrode driver further includes a seventh path selection unit for disconnecting the sustain electrode from the positive sustain electrode driver when the negative sustain electrode driver or the fourth sustain electrode energy recovery unit operates. The negative sustain electrode driver further includes an eighth path selection unit for disconnecting the sustain electrode from the negative sustain electrode driver when the positive sustain electrode driver or the third sustain electrode energy recovery unit operates.

According to another aspect of the present invention, there is provided a plasma display apparatus including: a plasma display panel including a scan electrode and a sustain electrode; a scan electrode driver alternately applying a first positive voltage and a second negative voltage to the scan electrode in a sustain period; and a sustain electrode driver applying a third positive voltage to the sustain electrode when the scan electrode driver applies the second negative voltage, and applying a fourth negative voltage to the sustain electrode when the scan electrode driver applies the first positive voltage, in the sustain period.

According to another aspect of the present invention, there is provided a driving method of a plasma display apparatus, including: alternately applying a first positive voltage and a second negative voltage to a scan electrode; and alternately applying a fourth negative voltage and a third positive voltage to a sustain electrode whenever the first positive voltage and the second negative voltage are alternately applied.

The first voltage with the positive value is a positive voltage corresponding to n (0<n<1, n is a real number) times of a value obtained by adding the absolute value of the first voltage to the absolute value of the fourth voltage, the second voltage with the negative value is a negative voltage corresponding to (1-m) times (0<m<1, m is a real number) of a value obtained by adding the absolute value of the second voltage to the absolute value of the third voltage, the fourth voltage with the negative value is a negative voltage corresponding to (1-n) times of the value obtained by adding the absolute value of the first voltage to the absolute value of the fourth voltage, and the third voltage with the positive value is a positive voltage corresponding to m times of the value obtained by adding the absolute value of the third voltage to the absolute value of the second voltage.

The first voltage with the positive value is a positive voltage corresponding to 0.5 times of a value obtained by adding the absolute value of the first voltage to the absolute value of the fourth voltage, the second voltage with the negative value is a negative voltage corresponding to 0.5 times of a value obtained by adding the absolute value of the second voltage to the absolute value of the third voltage, the fourth voltage with the negative value is a negative voltage corresponding to 0.5 times of the value obtained by adding the absolute value of the first voltage to the absolute value of the fourth voltage, and the third voltage with the positive value is a positive voltage corresponding to 0.5 times of the value obtained by adding the absolute value of the third voltage to the absolute value of the second voltage.

After energy corresponding to 0.5 times of the first positive voltage is applied through the scan electrode and then the first positive voltage is applied to the scan electrode, energy corresponding to 0.5 times of the first positive voltage is collected through the scan electrode. After energy corresponding to 0.5 times of the second negative voltage is applied through the scan electrode and then the second negative voltage is applied to the scan electrode, energy corresponding to 0.5 times of the second negative voltage is collected through the scan electrode. After energy corresponding to 0.5 times of the fourth negative voltage is supplied through the sustain electrode and then the fourth negative voltage is applied to the sustain electrode, energy corresponding to 0.5 times of the fourth negative voltage is collected through the sustain electrode. After energy corresponding to 0.5 times of the third positive voltage is supplied through the sustain electrode and then the third positive voltage is applied to the sustain electrode, energy corresponding to 0.5 times of the third positive voltage is collected through the sustain electrode.

Hereinafter, detailed embodiments of the present invention will be described with reference to the appended drawings.

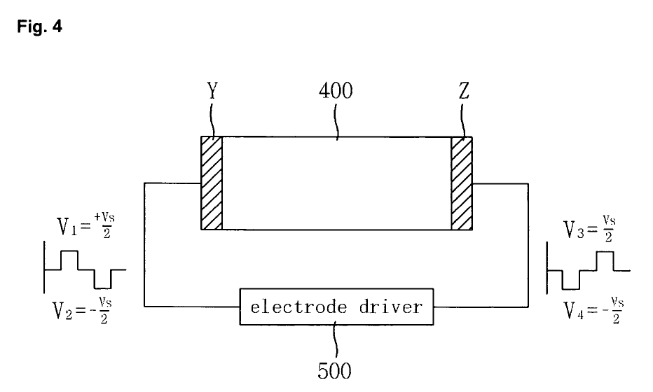

FIG. 4 is a block diagram of a plasma display apparatus according to the present invention. As shown in FIG. 4, the plasma display apparatus according to the present invention includes a plasma display panel and an electrode driver 500.

The plasma display panel 400 includes scan electrodes Y and sustains electrodes Z for maintaining the discharge of cells selected during an addressing period.

The electrode driver 500 alternately applies a fourth negative voltage V₄ and a third positive voltage V₃ to the sustain electrode Z whenever a first positive voltage V₁ and a second negative voltage V₂ are alternately applied to the scan electrode Y, in a sustain period.

As such, by causing the electrode driver 500 to alternately apply a positive voltage and a negative voltage to the scan electrode Y and alternately apply voltages with polarities respectively opposite to the voltages applied to the scan electrode Y, to the sustain electrode Z, the discharge of selected cells is maintained by the potential difference between the scan electrode Y and the sustain electrode Z.

At this time, it is preferable that the electrode driver 500 alternately applies, to the sustain electrode Z, a negative voltage corresponding to (1-n) times (0<n<1, n is a real number) of a value obtained by adding the absolute value of the first voltage V1 with the absolute value of the fourth voltage V4 and a positive voltage corresponding to m times (0<m<1, m is a real number) of a value obtained by adding the absolute value of the second voltage V2 with the absolute value of the third voltage V3, whenever alternately applying, to the scan electrode Y, a positive voltage corresponding to n times of a value obtained by adding the absolute value of the first voltage V1 with the absolute value of the fourth voltage V4 and a negative voltage corresponding to (1-m) times of a value obtained by adding the absolute value of the second V2 voltage with the absolute value of the third voltage V3.

More preferably, the electrode driver 500 alternately applies, to the sustain electrode Z, a negative voltage corresponding to 0.5 times of a value obtained by adding the absolute value of the first voltage V1 with the absolute value of the fourth voltage V4 and a positive voltage corresponding to 0.5 times of a value obtained by adding the absolute value of the second voltage V2 with the absolute value of the third voltage V3, whenever alternately applying, to the scan electrode Y, a positive voltage corresponding to 0.5 times of a value obtained by adding the absolute value of the first voltage V1 with the absolute value of the fourth voltage V4 and a negative voltage corresponding to 0.5 times of a value obtained by adding the absolute value of the second voltage V2 with the absolute value of the third voltage V3.

Accordingly, the electrode driver 500 according to the present invention applies a first voltage V₁, a second voltage V₂, a third voltage V₃, and a fourth voltage V₄ to the scan electrode Y and the sustain electrode Z, and the voltages V, through V₄ are lower than a sustain voltage which is applied to a scan electrode and a sustain electrode by the conventional plasma display apparatus. Therefore, the electrode driver 500 according to the present invention can perform a sustain-discharge of the plasma display panel 400 using devices having a low withstand voltage characteristic compared with conventional devices. As a result, the plasma display apparatus according to the present invention has advantages of minimizing manufacturing costs and reducing heat generation and power consumption caused by resistance components.

### First Embodiment

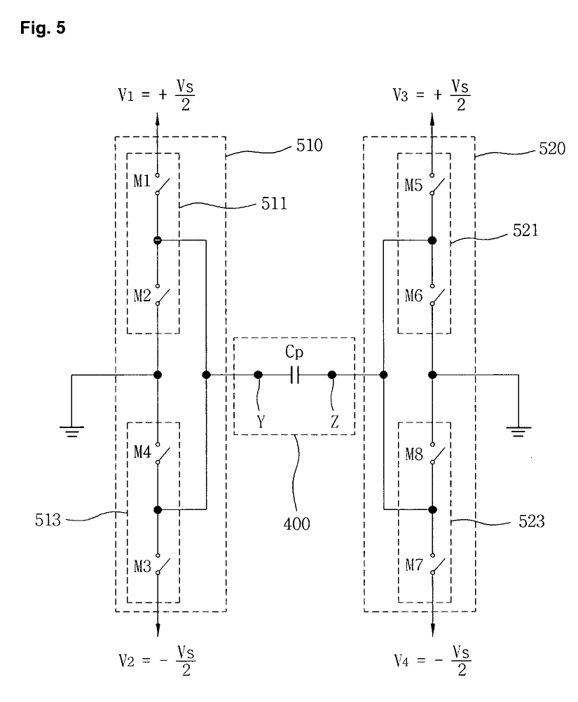

FIG. 5 is a circuit diagram of a plasma display apparatus according to an embodiment of the present invention. Referring to FIG. 5, the plasma display apparatus according to the first embodiment of the present invention includes a plasma display panel 400, a scan electrode driver 510, and a sustain electrode driver 520.

The plasma display panel 400 includes a scan electrode Y and a sustain electrode Z for maintaining the discharge of cells selected during an addressing period. In FIG. 5, a reference symbol Cₚ denotes a capacitance component between the scan electrode Y and the sustain electrode Z which is equivalent to a panel capacitor.

The scan electrode driver 510 alternately applies a first positive voltage V₁ and a second negative voltage V₂ to the scan electrode Y in sustain period. The scan electrode driver 510 includes a positive scan electrode driver 511 for applying the first positive voltage V₁ and a negative scan electrode driver 513 for applying the second negative voltage V₂.

The sustain electrode driver 520 applies a third positive voltage V₃ to the sustain electrode Z when the scan electrode driver 510 applies the second negative voltage V₂, and applies a fourth negative voltage V₄ to the sustain electrode Z when the scan electrode driver 510 applies the first positive voltage V₁, in the sustain period. The sustain electrode driver 520 includes a positive sustain electrode driver 521 for applying the third positive voltage V₃ when the negative scan electrode driver 513 applies the second negative voltage V₂, and a negative sustain electrode driver 523 for applying the fourth negative voltage V₄ when the positive scan electrode driver 511 applies the first positive voltage V₁.

Here, the positive scan electrode driver 511 includes a first switch M1 and a second switch M2. The first switch M1 has one end connected to a first supply voltage for supplying the first positive voltage V₁ and the other end connected to the scan electrode Y. The second switch M2 has one end connected to the scan electrode Y and the other end connected to a ground.

The negative scan electrode driver 513 includes a third switch M3 and a fourth switch M4. The third switch M3 has one end connected to a second supply voltage for supplying the second negative voltage V₂ and the other end connected to the scan electrode Y. The fourth switch M4 has one end connected to the scan electrode Y and the other end connected to the ground.

The positive sustain electrode driver 521 includes a fifth switch M5 and a sixth switch M6. The fifth switch M5 has one end connected to a third supply voltage for supplying the third positive voltage V₃ and the other end connected to the sustain electrode Z. The sixth switch M6 has one end connected to the sustain electrode Z and the other end connected to the ground.

The negative sustain electrode driver 523 includes a seventh switch M7 and an eighth switch M8. The seventh switch M7 has one end connected to a fourth supply voltage for supplying the fourth negative voltage V₄ and the other end connected to the sustain electrode Z. The eighth switch M8 has one end connected to the sustain electrode Z and the other end connected to the ground.

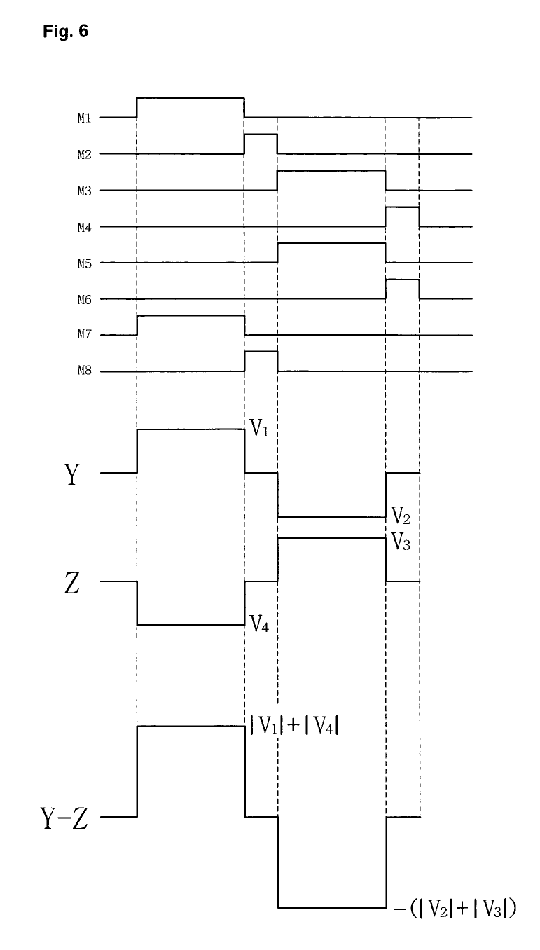

Now, the operation of the plasma display apparatus according to the first embodiment of the present invention will be described in detail with reference to FIG. 6.

FIG. 6 shows switching timing diagrams and sustain pulse waveform diagrams which are implemented by the plasma display apparatus according to the first embodiment of the present invention. As shown in FIG. 6, in a sustain period, the first switch M1 and the seventh switch M7 are turned on at the same time. Accordingly, the first voltage V₁ and the fourth voltage V₄ are simultaneously applied to the scan electrode Y and the sustain electrode Z. As such, if the first voltage V, and the fourth voltage V₄ are simultaneously applied, the potential difference between the scan electrode Y and the sustain electrode Z becomes a sum of the magnitude of the first voltage V₁ and the magnitude of the fourth voltage V₄.

Then, the second switch M2 and the eighth switch M8 are turned on at the same time and the remaining switches are turned off. Accordingly, the scan electrode Y and the sustain electrode Z are connected to the ground. As such, if the scan electrode Y and the sustain electrode Z are connected to the ground, the potential difference between the scan electrode Y and the sustain electrode Z becomes 0 Volt.

Successively, the third switch M3 and the fifth switch M5 are turned on at the same time and the remaining switches are turned off. Accordingly, the second voltage V₂ and the third voltage V₃ are simultaneously applied to the scan electrode Y and the sustain electrode Z. As such, if the second voltage V₂ and the third voltage V₃ are simultaneously applied, the potential difference between the scan electrode Y and the sustain electrode Z becomes a sum of the magnitude of the second voltage V₂ and the magnitude of the third voltage V₃.

Then, the fourth switch M4 and the sixth switch M6 are turned on at the same time and the remaining switches are turned off. Accordingly, the scan electrode Y and the sustain electrode Z are connected to the ground. As such, if the scan electrode Y and the sustain electrode Z are connected to the ground, the potential difference between the scan electrode Y and the sustain electrode Z becomes 0 Volt.

As such, since a discharge is maintained without using a high sustain voltage by performing a sustain discharge through the potential difference between a scan electrode Y and a sustain electrode Z, switching devices having a low withstand voltage characteristic can be used. Therefore, the plasma display apparatus according to the present invention has advantages of minimizing manufacturing costs and reducing heat generation and power consumption due to resistance components.

### Second Embodiment

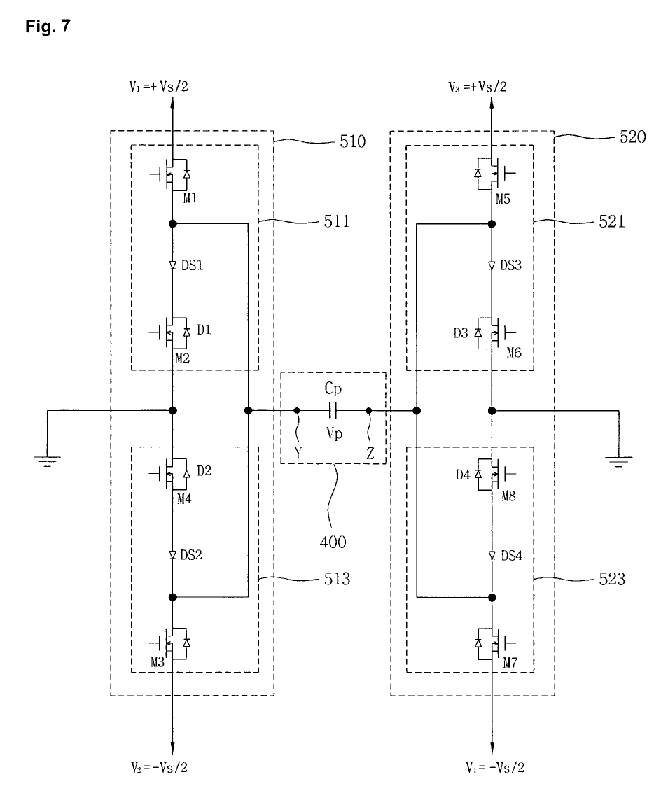

FIG. 7 is a circuit diagram of a plasma display apparatus according to a second embodiment of the present invention. Referring to FIG. 7, the plasma display apparatus according to the second embodiment of the present invention further includes first through fourth short prevention diodes DS1 through DS4 for short prevention, wherein the switches M1 through M8 are field effect transistors (FETs). In the case where the second switch M2, the fourth switch M4, the sixth switch M6, and the eighth switch M8 are FETs, first through fourth diodes D1 through D4 which are body diodes are respectively formed in the respective switches M2, M4, M6, and M8.

The cathode terminal of the first diode D1 is connected to one end of the second switch M2 and the anode terminal of the first diode D1 is connected to the other end of the second switch M2.

The anode terminal of the first short prevention diode DS1 is connected to a scan electrode Y and the cathode terminal of the first short prevention diode DS1 is connected to one end of the second switch M2.

The anode terminal of the second diode D2 is connected to one end of the fourth switch M4 and the cathode terminal of the second diode D2 is connected to the other end of the fourth switch M4.

The cathode terminal of the second short prevention diode DS2 is connected to the scan electrode Y and the anode terminal of the second short prevention diode DS2 is connected to one end of the forth switch M4.

The anode terminal of the third diode D3 is connected to the other end of the sixth switch M6 and the cathode terminal of the third diode D3 is connected to one end of the sixth switch M6.

The anode terminal of the third short prevention diode DS3 is connected to a sustain electrode Z and the cathode terminal of the third short prevention diode DS3 is connected to one end of the sixth switch M6.

The anode terminal of the fourth diode D4 is connected to one end of the eighth switch M8 and the cathode terminal of the fourth diode D4 is connected to the other end of the eighth switch M8.

The cathode terminal of the fourth short prevention diode DS4 is connected to the sustain electrode Z and the anode terminal of the fourth short prevention diode DS4 is connected to one end of the eighth switch M8.

The first through fourth short prevention diodes DS1 through DS4 connected in such a manner prevent the scan electrode Y or the sustain electrode Z from being grounded and thus shorted when the first through fourth voltages V₁ through V₄ are respectively applied to the scan electrode Y or the sustain electrode Z.

For example, if the first short prevention diode DS1 does not exist, the first voltage V₁ is applied to the scan electrode Y when the first switch M1 is turned on. The first voltage V₁ applied to the scan electrode Y is applied to the ground through the second diode D2 which is a body diode, although the fourth switch M4 is turned off. Accordingly, the first short prevention diode DS1 acts to prevent the scan electrode Y from being shorted. Likewise, the second short prevention diode DS2 acts to prevent the scan electrode Y from being shorted through the first diode D1 which is a body diode of the second switch M2, when the second voltage V₂ is applied to the scan electrode Y. The third short prevention diode DS3 acts to prevent the sustain electrode Z from being shorted through the fourth diode D4 which is a body diode of the eighth switch M8, when the third voltage V₃ is applied to the sustain electrode Z. Also, the fourth short prevention diode DS4 acts to prevent the sustain electrode Z from being shorted through the third diode D3 which is a body diode of the sixth switch M6, when the fourth voltage V₄ is applied to the sustain electrode Z.

Here, at least one of the first through fourth short prevention diodes DS1 through DS4 is a fast recovery diode. The fast recovery diode can efficiently perform short prevention since it has a short recovery time.

Switching timings and sustain pulse waveforms which are implemented by the plasma display apparatus according to the second embodiment are the same as those which are implemented by the plasma display apparatus according to the first embodiment, and therefore detailed descriptions thereof are omitted.

### Third Embodiment

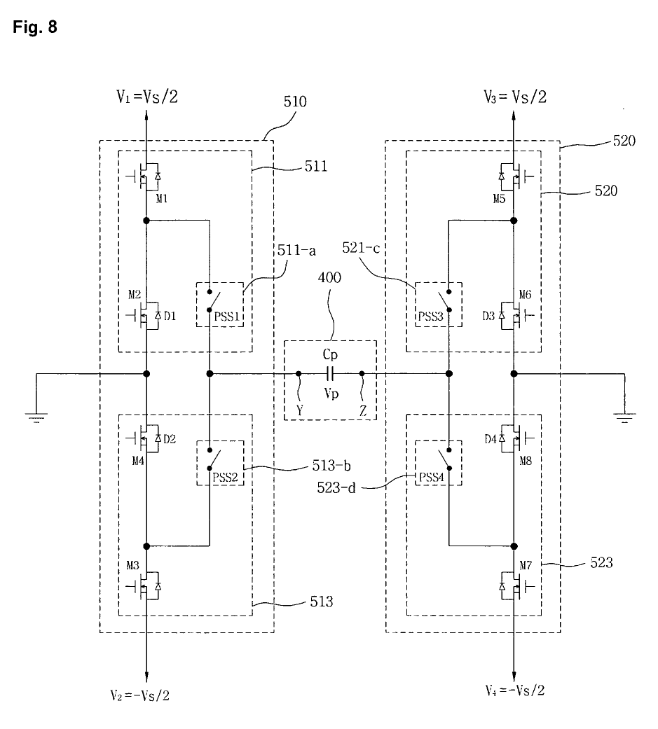

FIG. 8 is a circuit diagram of a plasma display apparatus according to a third embodiment of the present invention. As shown in FIG. 8, each of the positive scan electrode driver 511, the negative scan electrode driver 513, the positive sustain electrode driver 521, and the negative sustain electrode driver 523 of the first embodiment further includes a path selection unit for short prevention. Here, the switches M1 through M8 are FETs.

The positive scan electrode driver 511 includes a first path selection unit 511-a for disconnecting the scan electrode Y from the positive scan electrode driver 511 when the negative scan electrode driver 513 operates.

The negative scan electrode driver 513 includes a second path selection unit 513-b for disconnecting the scan electrode Y from the negative scan electrode driver 513 when the positive scan electrode driver 511 operates.

Here, the first path selection unit 511-a includes a first path selection switch PSS1 having one end connected to the scan electrode Y and the other end connected to one end of the second switch M2.

The second path selection unit 513-b includes a second path selection switch PSS2 having one end connected to the scan electrode Y and the other end connected to one end of the fourth switch M4.

Also, the positive sustain electrode driver 521 includes a third path selection unit 521-c for disconnecting the sustain electrode Z from the positive sustain electrode driver 521 when the negative sustain electrode driver 523 operates.

The negative sustain electrode driver 523 includes a fourth path selection unit 523-d for disconnecting the sustain electrode Z from the negative sustain electrode driver 523 when the positive sustain electrode driver 521 operates.

Here, the third path selection unit 521-c includes a third path selection switch PSS3 having one end connected to the sustain electrode Z and the other end connected to one end of the sixth switch M6.

The fourth path selection unit 523-d includes a fourth path selection switch PSS4 having one end connected to the sustain electrode Z and the other end connected to one end of the eighth switch M8.

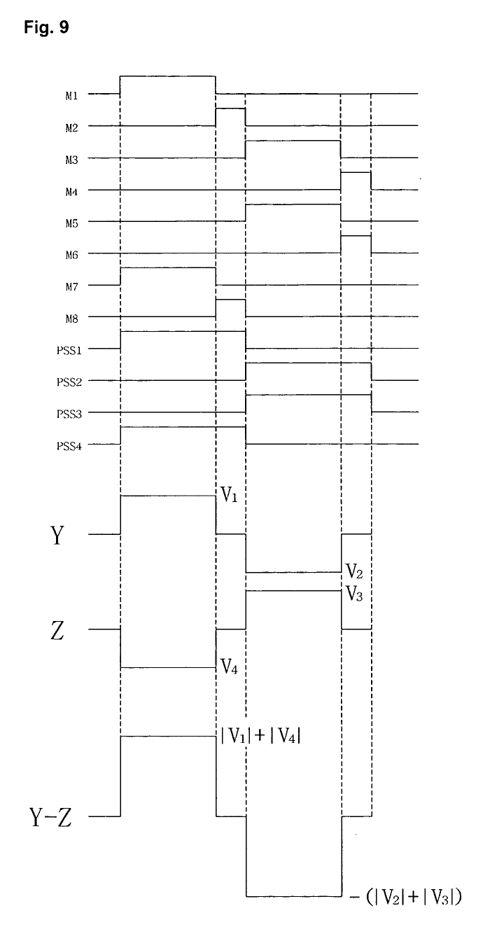

Hereinafter, the operation of the plasma display apparatus according to the third embodiment of the present invention will be described in detail with reference to FIG. 9.

FIG. 9 shows switching timing diagrams and sustain pulse waveform diagrams which are implemented by the plasma display apparatus according to the third embodiment of the present invention. As shown in FIG. 9, the operations of the first through eighth switches M1 through M8 and the waveforms of sustain pluses are the same as those of the first embodiment and therefore detailed descriptions thereof are omitted.

In order to apply the first voltage V₁ to the scan electrode Y by turning on the first switch M1 and apply the fourth voltage V₄ to the sustain electrode Z by turning on the seventh switch M7, the first path selection switch PSS1 and the fourth path selection switch PSS4 should be turned on. In this operation, in order to prevent the first voltage V₁ and the fourth voltage V₄ from being applied to the ground through the second diode D2 of the fourth switch M4 and the third diode D3 of the sixth switch M6, the second selection switch PSS2 and the third selection switch PSS3 should be turned off.

In order to apply the third voltage V₃ to the sustain electrode Z by turning on the fifth switch M5 and apply the second voltage V₂ to the scan electrode Y by turning on the third switch M3, the third path selection switch PSS3 and the second path selection switch PSS2 should be turned on. In this operation, in order to prevent the third voltage V₃ and the second voltage V₂ from being applied to the ground through the fourth diode D4 of the eighth switch M8 and the first diode D1 of the second switch M2, the first path selection switch PSS1 and the fourth path selection switch PSS 4 should be turned off.

### Fourth Embodiment

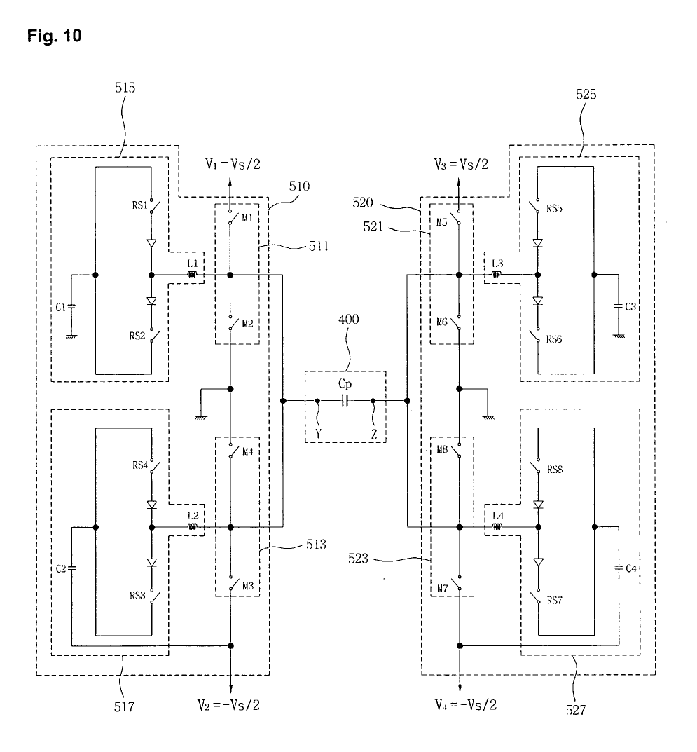

FIG. 10 is a circuit diagram of a plasma display apparatus according to a fourth embodiment of the present invention. As shown in FIG. 10, the fourth embodiment of the present invention is implemented by adding an energy recovery circuit unit to the configuration of the first embodiment.

That is, the scan electrode driver 510 includes a positive scan electrode driver 511, a negative scan electrode driver 513, a first scan electrode energy recovery unit 515, and a second scan electrode energy recovery unit 517.

The first scan electrode energy recovery unit 515 supplies energy corresponding to 0.5 times of a first positive voltage V₁ to the scan electrode Y through a first capacitor C1 and a first energy recovery switch RS1 using resonance between a first inductor L1 and the panel capacitor Cp. After the positive scan electrode driver 511 applies the first positive voltage V₁ to the scan electrode Y, the first scan electrode energy recovery unit 515 collects energy corresponding to 0.5 times of the first positive voltage V₁ in the first capacitor C1 using resonance between the first inductor L1 and the panel capacitor Cₚ when a second energy recovery switch RS2 is turned on.

The second scan electrode energy recovery unit 517 supplies energy corresponding to 0.5 times of a second negative voltage V₂ to the scan electrode Y through a second capacitor C2 and a third energy recovery switch RS3 using resonance between a second inductor L2 and the panel capacitor Cp. After the negative scan electrode driver 517 applies the negative second voltage V₂ to the scan electrode Y, the second scan electrode energy recovery unit 517 collects energy corresponding to 0.5 times of the negative second voltage V₂ in the second capacitor C2 using resonance between the second inductor L2 and the panel capacitor Cₚ when the fourth energy recovery switch RS4 is turned on.

The third sustain electrode energy recovery unit 525 supplies energy corresponding to 0.5 times of a third positive voltage V₃ to the sustain electrode Z through a third capacitor C3 and a fifth energy recovery switch RS5 using resonance between a third inductor L3 and the panel capacitor Cₚ when the second scan electrode energy recovery unit 517 supplies the energy. After the positive sustain electrode driver 521 applies the third positive voltage V₃ to the sustain electrode Z, the third sustain electrode energy recovery unit 525 collects energy corresponding to 0.5 times of the third positive voltage V₃ in the third capacitor C3 using resonance between the third inductor L3 and the panel capacitor Cₚ when a sixth energy recovery switch RS6 is turned on.

The fourth sustain electrode energy recovery unit 527 supplies energy corresponding to 0.5 times of a fourth negative voltage V₄ to the sustain electrode Z through a fourth capacitor C4 and a seventh energy recovery switch RS7 using resonance between a fourth inductor L4 and the panel capacitor Cₚ when the first scan electrode energy recovery unit 515 supplies the energy. After the negative sustain electrode driver 523 applies the fourth negative voltage V₄ to the sustain electrode Z, the fourth sustain electrode energy recovery unit 527 collects energy corresponding to 0.5 times of the fourth negative voltage V₄ in the fourth capacitor C4 using resonance between a fourth inductor L4 and the panel capacitor Cp when an eighth energy recovery switch RS8 is turned on.

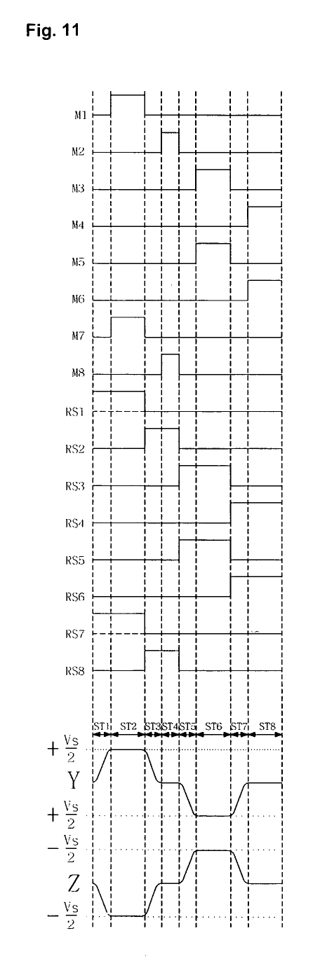

Hereinafter, the operation of the plasma display apparatus according to the fourth embodiment of the present invention will be described in detail with reference to FIG. 11.

FIG. 11 shows switching timing diagrams and sustain pulse waveform diagrams which are implemented by the plasma display apparatus according to the fourth embodiment of the present invention. It is seen in FIG. 11 that when the first voltage V₁ and the fourth voltage V₄ are applied to the scan electrode Y and the sustain electrode Z and the second voltage V₂ and the third voltage V₃ are applied to the scan electrode Y and the sustain electrode Z through the operations of the switches, energy is supplied and collected using resonance between the inductors and the panel capacitor Cp.

First, in a first state ST1, the first energy recovery switch RS1 and the seventh energy recovery switch RS7 are turned on. Accordingly, energy is supplied from the first capacitor C1 to the scan electrode Y by resonance between the first inductor L1 and the panel capacitor Cₚ, and energy is supplied from the fourth capacitor C4 to the sustain electrode Z by resonance between the fourth inductor L4 and the panel capacitor Cp.

In a second state ST2, while the first energy recovery switch RS1 and the seventh energy recovery switch RS7 remain turned-on, the first switch M1 and the seventh switch M7 are turned on. Accordingly, the voltages of the scan electrode Y and the sustain electrode Z are respectively maintained at the first voltage V₁ and the fourth voltage V₄.

In a third state ST3, the second energy recovery switch RS2 and the eighth energy recovery switch RS8 are turned on. Accordingly, energy is collected from the scan electrode Y by resonance between the first inductor L1 and the panel capacitor Cₚ and energy is collected from the sustain electrode Z by resonance between the fourth inductor L4 and the panel capacitor Cp.

In a fourth state ST4, while the second energy recovery switch RS2 and the eighth energy recovery switch RS8 remain turned-on, the second switch M2 and the eighth switch M8 are turned on. Accordingly, the voltages of the scan electrode Y and the sustain electrode Z are maintained at a ground voltage.

In a fifth state ST5, the third energy recovery switch RS3 and the fifth energy recovery switch RS5 are turned on. Accordingly, energy is supplied from the second capacitor C2 to the scan electrode Y by resonance between the second inductor L2 and the panel capacitor Cₚ and energy is supplied from the third capacitor C3 to the sustain electrode by resonance between the third inductor L3 and the panel capacitor Cp.

In a sixth state ST6, while the third energy recovery switch RS3 and the fifth energy recovery switch RS5 remain turned-on, the third switch M3 and the fifth switch M5 are turned on. Accordingly, the voltages of the scan electrode Y the sustain electrode Z are respectively maintained at the second voltage V₂ and the third voltage V₃.

In a seventh state ST7, the fourth energy recovery switch RS4 and the sixth energy recovery switch RS6 are turned on. Accordingly, energy is collected from the scan electrode Y by resonance between the second inductor L2 and the panel capacitor Cₚ and energy is collected from the sustain electrode Z by resonance between the third inductor L3 and the panel capacitor Cp.

In an eighth state ST8, while the fourth energy recovery switch RS4 and the sixth energy recovery switch RS6 remain turned-on, the fourth switch M4 and the sixth switch M6 are turned on. Accordingly, the voltages of the scan electrode Y and the sustain electrode Z are maintained at the ground voltage.

Since the plasma display apparatus according to the fourth embodiment of the present invention also maintains a discharge using the potential difference between a scan electrode Y and a sustain electrode Z, it is possible to maintain a discharge without using a high sustain voltage as in the conventional technique and thus use switching devices having a low withstand voltage characteristic.

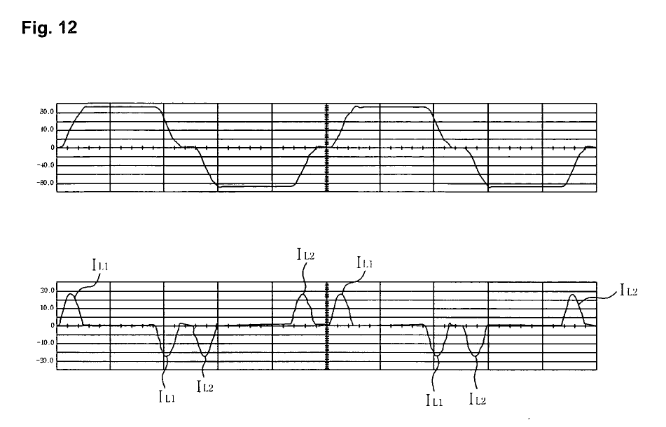

FIG. 12 shows waveform diagrams of current flowing through an inductor of the plasma display apparatus according to the fourth embodiment of the present invention. In FIG. 12, changes in current flowing through the first inductor L1 and the second inductor L2 while a first voltage and a second voltage are alternately applied to the scan electrode Y, are shown. It is seen in FIG. 12 that the plasma display apparatus according to the fourth embodiment of the present invention supplies and collects energy through resonance.

Since the plasma display apparatus according to the fourth embodiment of the present invention also maintains a discharge using the potential difference between a scan electrode Y and a sustain electrode Z, it is possible to maintain a discharge without using a high sustain voltage as in the conventional technique and thus use switching devices having a low withstand voltage characteristic. As a result, the plasma display apparatus has advantages of minimizing manufacturing costs and reducing heat generation and power consumption due to resistance components.

### Fifth Embodiment

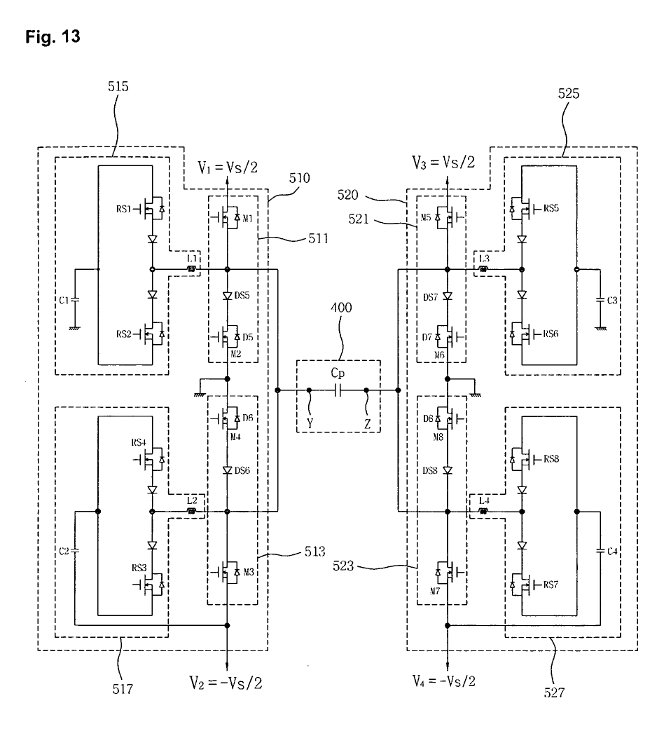

FIG. 13 is a circuit diagram of a plasma display apparatus according to a fifth embodiment of the present invention. The plasma display apparatus according to the fifth embodiment of the present invention further includes fifth through eighth short prevention diodes DS5 through DS8, in order to block the influences of the fifth through eighth diodes D5 through D8, which are body diodes, formed in the respective switches in case where the second switch M2, the fourth switch M4, the sixth switch M6, and the eighth switch M8 of the fourth embodiment described above are FETs.

That is, the positive scan electrode driver 511 further includes the fifth short prevention diode DS5 for preventing the second voltage V₂ from being applied to the ground when the second voltage V₂ is applied after the second scan electrode energy recovery unit 517 supplies energy.

The negative scan electrode driver 513 further includes the sixth short prevention diode DS6 for preventing the first voltage V₁ from being applied to the ground when the first voltage V₁ is applied after the first scan electrode energy recovery unit 515 supplies energy.

The positive sustain electrode driver 521 further includes the seventh short prevention diode DS7 for preventing the fourth voltage V₄ from being applied to the ground when the fourth voltage V₄ is applied after the fourth scan electrode energy recovery unit 527 supplies energy.

The negative sustain electrode driver 523 further includes the eighth short prevention diode DS8 for preventing the third voltage V₃ from being applied to the ground when the third voltage V₃ is applied after the third scan electrode energy recovery unit 525 supplies energy.

The cathode terminal of the fifth diode D5 is connected to one end of the second switch M2 and the anode terminal of the fifth diode D5 connected to the other end of the second switch M2.

The anode terminal of the fifth short prevention diode DS5 is connected to the scan electrode Y and the cathode terminal of the fifth short prevention diode DS5 is connected to one end of the second switch M2.

The anode terminal of the sixth diode D6 is connected to one end of the fourth switch M4 and a cathode terminal connected to the other end of the fourth switch M4.

The cathode terminal of the sixth short prevention diode DS6 is connected to the scan electrode Y and the anode terminal of the sixth short prevention diode DS6 is connected to one end of the fourth switch M4.

The cathode terminal of the seventh diode D7 is connected to one end of the sixth switch M6 and the anode terminal of the seventh diode D7 is connected to the other end of the sixth switch M6.

The anode terminal of the seventh short prevention diode DS7 is connected to the sustain electrode Z and the cathode terminal of the seventh short prevention diode DS7 is connected to one end of the sixth switch M6.

The anode terminal of the eighth diode D8 is connected to one end of the eighth switch M8 and the cathode terminal of the eighth diode D8 is connected to the other end of the eighth switch M8.

The cathode terminal of the eighth short prevention diode DS8 is connected to the sustain electrode Z and the anode terminal of the eighth short prevention diode DS8 is connected to one end of the fourth switch M4.

Hereinafter, the operation of the plasma display apparatus according to the fifth embodiment of the present invention will be described in detail with reference to FIG. 11.

Switching timing diagrams and sustain pulse waveform diagrams which are implemented by the plasma display apparatus according to the fifth embodiment of the present invention, are shown in FIG. 11. The fifth short prevention diode DS5 and the eighth short prevention diode DS8 of the plasma display apparatus according to the fifth embodiment prevent the second voltage V₂ and the third voltage V₃ from being applied to the ground through the fifth diode D5 of the second switch M2 and the eighth diode D8 of the eighth switch M8 in the fourth state ST4 when the second voltage V₂ and the third voltage V₃ are respectively applied to the scan electrode Y and the sustain electrode Z. The sixth short prevention diode DS6 and the seventh short prevention diode DS7 prevent the first voltage V1 and the fourth voltage V₄ from being applied to the ground through the sixth diode D6 of the fourth switch M4 and the seventh diode D7 of the sixth switch M6 in the second state ST2 when the first voltage V₁ and the fourth voltage V₄ are respectively applied to the scan electrode Y and the sustain electrode Z.

At this time, at least one of the fifth through eighth short prevention diodes DS5 through DS8 is a fast recovery diode. The fast recovery diode can efficiently perform short prevention since it has a short recovery time.

### Sixth Embodiment

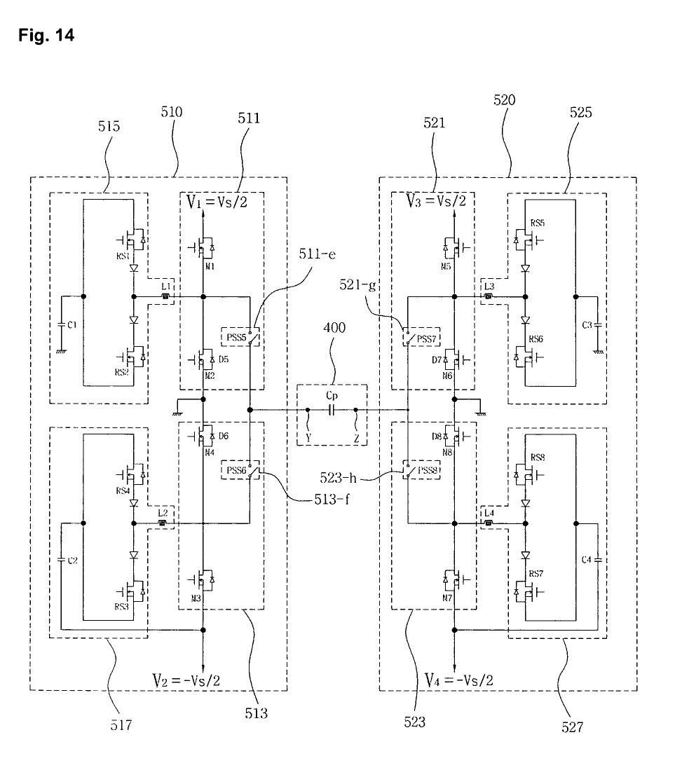

FIG. 14 is a circuit diagram of a plasma display apparatus according to a sixth embodiment of the present invention. In the plasma display apparatus according to the sixth embodiment of the present invention, each of the positive scan electrode driver 511, the negative scan electrode driver 513, the positive sustain electrode driver 521, and the negative sustain electrode driver 523 further includes a path selection unit for short prevention, in order to block the influences of the fifth through eighth diodes D5 through D8, which are body diodes, formed in the respective switches in case where the second switch M2, the fourth switch M4, the sixth switch M6, and the eighth switch M8 of the plasma display apparatus according to the fourth embodiment described above are FETs.

The positive scan electrode driver 511 includes a fifth path selection unit 511-e for disconnecting the scan electrode Y from the scan electrode driver 511 when the negative scan electrode driver 513 operates.

The negative scan electrode driver 513 includes a sixth path selection unit 513-f from disconnecting the scan electrode Y from the scan electrode driver 513 when the positive scan electrode driver 511 operates.

Here, the fifth path selection unit 511-e includes a fifth path selection switch PSS5 having one end connected to the scan electrode Y and the other end connected to one end of the second switch M2.

The sixth path selection unit 513-f includes a sixth path selection switch PSS6 having one end connected to the scan electrode Y and the other end connected to one end of the fourth switch M4.

Also, the positive sustain electrode driver 521 includes a seventh path selection unit 521-g for disconnecting the sustain electrode Z from the positive sustain electrode driver 521 when the negative sustain electrode driver 523 operates.

The negative sustain electrode driver 523 includes an eighth path selection unit 523-h for disconnecting the sustain electrode Z from the negative sustain electrode driver 523 when the positive sustain electrode driver 521 operates.

Here, the seventh path selection unit 521-g includes a seventh path selection switch PSS7 having one end connected to the sustain electrode Z and the other end connected to one end of the sixth switch M6.

The fourth path selection unit 523-h includes an eighth path selection switch PSS8 having one end connected to the sustain electrode Z and the other end connected to one end of the eighth switch M8.

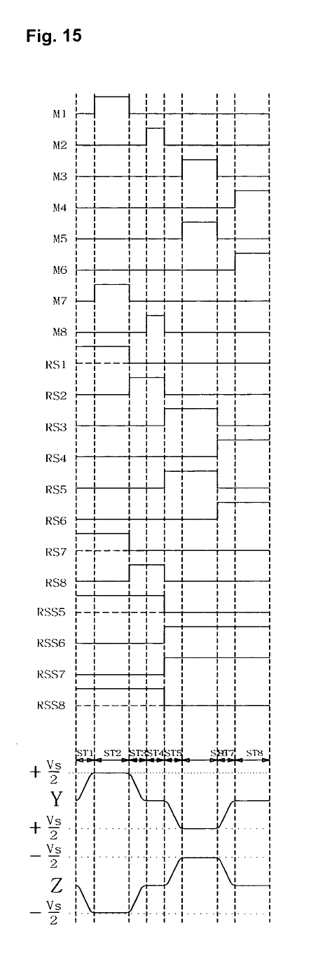

Hereinafter, the operation of the plasma display apparatus according to the sixth embodiment of the present invention will be described in detail with reference to FIG. 15.

FIG. 15 shows switching timing diagrams and sustain pulse waveform diagrams which are implemented by the plasma display apparatus according to the sixth embodiment of the present invention. As shown in FIG. 15, the operations and the waveforms of sustain pulses which are implemented by the first through eighth switches M1 through M8 and the first through eighth energy recovery switches RS1 through RS8, are the same as those of the fourth embodiment shown in FIG. 11, and therefore detailed descriptions thereof are omitted.

In order to apply the first voltage V, to the scan electrode Y by turning on the first switch M1 and apply the fourth voltage V₄ to the sustain electrode Z by turning on the seventh switch M7, the fifth path selection switch PSS5 and the eighth path selection switch PSS8 should be turned on. In this operation, in order to prevent the first voltage V₁ and the fourth voltage V₄ from being applied to the ground through the sixth diode D6 of the fourth switch M4 and the seventh diode D7 of the sixth switch M6, the sixth path selection switch PSS6 and the seventh path selection switch PSS7 should be turned off.

Also, in order to apply the third voltage V₃ to the sustain electrode Z by turning on the fifth switch M5 and apply the second voltage V₂ to the scan electrode Y by turning on the third switch M3, the seventh path selection switch PSS7 and the sixth path selection switch PSS6 should be turned on. In this operation, in order to prevent the third voltage V₃ and the second voltage V₂ from being applied to the ground through the eighth diode D8 of the eighth switch M8 and the fifth diode D5 of the second switch M2, the fifth path selection switch PSS5 and the eighth path selection switch PSS8 should be turned off.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel including a scan electrode and a sustain electrode; and
an electrode driver for alternately applying a fourth voltage of a negative voltage and a third voltage of a positive voltage to the sustain electrode while the scan electrode is applied with a first voltage of a positive voltage and a second voltage of a negative voltage in a sustain period.

2. The plasma display apparatus according to claim 1, wherein the electrode driver alternately applies, to the sustain electrode, a negative voltage corresponding to (1-n) times (0<n<1, n is a real number) of a value obtained by adding the absolute value of the first voltage with the absolute value of the fourth voltage and a positive voltage corresponding to m times (0<m<1, m is a real number) of a value obtained by adding the absolute value of the second voltage with the absolute value of the third voltage, whenever alternately applying, to the scan electrode, a positive voltage corresponding to n times of a value obtained by adding the absolute value of the first voltage with the absolute value of the fourth voltage and a negative voltage corresponding to (1-m) times of a value obtained by adding the absolute value of the second voltage with the absolute value of the third voltage.

3. The plasma display apparatus according to claim 2, wherein the electrode driver alternately applies, to the sustain electrode, a negative voltage corresponding to 0.5 times of a value obtained by adding the absolute value of the first voltage with the absolute value of the fourth voltage and a positive voltage corresponding to 0.5 times of a value obtained by adding the absolute value of the second voltage with the absolute value of the third voltage, whenever alternately applying, to the scan electrode, a positive voltage corresponding to 0.5 times of a value obtained by adding the absolute value of the first voltage with the absolute value of the fourth voltage and a negative voltage corresponding to 0.5 times of a value obtained by adding the absolute value of the second voltage with the absolute value of the third voltage.

4. The plasma display apparatus according to claim 1, wherein the electrode driver includes:
a) a scan electrode drier for alternately applying the first voltage of positive voltage and the second voltage of negative voltage to the scan electrode in the sustain electrode; and
b) a sustain period driver for applying the third voltage of positive voltage to the sustain period while the scan electrode driver applies the second voltage of negative voltage to the scan electrode in the sustain period, and applied the fourth voltage of negative voltage to the sustain period while the scan electrode driver applies the first voltage of positive voltage to the scan electrode.

5. The plasma display apparatus according to claim 4,
wherein the scan electrode driver includes:
a positive scan electrode driver for applying the first voltage of the positive voltage and a negative scan electrode driver for applying the second voltage of negative voltage, and
wherein the sustain electrode driver includes:
a positive sustain electrode driver for applying the third voltage of positive voltage when the negative scan electrode driver applied the second voltage of negative voltage and a negative sustain electrode driver for applying the fourth voltage of positive voltage when the scan electrode applied the first voltage of positive voltage.

6. The plasma display apparatus according to claim 5,
wherein the positive scan electrode driver includes a first switch with one terminal connected to a first voltage source supplying the first voltage of the positive voltage and the other terminal connected to the scan electrode and a second switch with one terminal connected to the scan electrode and the other terminal connected to a ground,
wherein the negative scan electrode driver includes a third switch with one terminal connected to a second voltage source supplying the second voltage of the negative voltage and the other terminal connected to scan electrode and a fourth switch with one terminal connected to the scan electrode and the other terminal connected to a ground,
wherein the positive sustain electrode driver includes a fifth switch with one terminal connected to a third voltage source supplying the third voltage of the positive voltage and the other terminal connected to the sustain electrode and a sixth switch with one terminal connected to the sustain electrode and the other terminal connected to a ground, and
wherein the negative sustain electrode driver includes a seventh switch with one terminal connected to a fourth voltage source supplying the fourth voltage of the negative voltage and the other terminal connected to the sustain electrode and an eighth switch with one terminal connected to the sustain electrode and the other terminal connected to a ground.

7. The plasma display apparatus according to claim 6,
wherein the positive scan electrode driver further includes: a) a first diode with an anode terminal connected to the other terminal of the second switch and a cathode terminal connected to the one terminal of the second switch; and b) a first short prevention diode with an anode terminal connected to the scan electrode and a cathode terminal connected to the one terminal of the second switch,
wherein the negative scan electrode further includes: c) a second diode with an anode terminal connected to one terminal of the fourth switch and a cathode terminal connected to the other terminal of the fourth switch; and d) a second short prevention diode with a cathode terminal connected to the scan electrode and an anode terminal connected to the one terminal of the fourth switch,
wherein the positive sustain electrode driver further includes: e) a third diode with an anode terminal connected to the other terminal of the sixth switch and a cathode terminal connected to the one terminal of the sixth switch; and f) a third short prevention diode with an anode terminal connected to the sustain electrode and a cathode terminal connected to the one terminal of the sixth switch, and
wherein the negative sustain electrode driver further includes: g) a fourth diode with an anode terminal connected to the one terminal of the eighth switch and a cathode terminal connected to the other terminal of the eighth switch; and
h) a fourth short diode with a cathode terminal connected to the sustain electrode and an anode terminal connected to the other terminal of the fourth switch.

8. The plasma display apparatus according to claim 7, wherein at least one of the first, second, third and fourth short prevention diodes is a fast recovery diode.

9. The plasma display apparatus according to claim 6, wherein the positive scan electrode driver further includes a first path selection part for isolating the scan electrode from the positive scan electrode driver while negative scan electrode driver operates, and wherein the negative scan electrode driver further includes a second path selection part for isolating the scan electrode from the negative scan electrode driver while the positive scan electrode driver operates.

10. The plasma display apparatus according to claim 9, wherein the first path selection part includes a first path selection switch with one terminal connected to the scan electrode and the other terminal connected to the one terminal of the second switch, and wherein the second path selection part includes a second path selection switch with one terminal connected to the scan electrode and the other terminal connected to the one terminal of the fourth switch.

11. The plasma display apparatus according to claim 6, wherein the positive sustain electrode driver further includes a third path selection part for isolating the sustain electrode from the positive sustain electrode driver while the negative sustain electrode driver operates, and wherein the negative sustain electrode driver further includes a fourth path selection part for isolating the sustain electrode from the negative sustain electrode driver while the positive sustain electrode driver operates.

12. The plasma display apparatus according to claim 11, wherein the third path selection part includes a third path selection switch with one terminal connected to the sustain electrode and the other terminal connected to the one terminal of the sixth switch, and wherein the fourth path selection part includes a fourth pas with one terminal connected to the sustain electrode and the other terminal connected to the other terminal of the eight switch.

13. The plasma display apparatus according to claim 5,
wherein the scan electrode driver includes:
a) a first energy recovery part for a scan electrode applying energy corresponding to 0.5 times of the first voltage of positive voltage to the scan electrode by resonance and recovering energy correspondent to 0.5 times of the first voltage of positive voltage by resonance after the positive scan electrode driver applies the first voltage of the positive voltage to the scan electrode; and
b) a second energy recover part for a scan electrode for applying energy corresponding to 0.5 times of the second voltage of the negative voltage by resonance to the scan electrode and recovering energy corresponding to 0.5 times of the second voltage of the negative voltage by resonance after the negative scan electrode driver applied the second voltage of the negative voltage to the scan electrode,
wherein the sustain electrode driver includes:
c) a third energy recovery part for a sustain electrode for applying energy corresponding to 0.5 times of the third voltage of the positive voltage to the sustain electrode by resonance when the second energy recovery part applied the energy and recovering energy corresponding to 0,5 times of the third voltage of the positive voltage by resonance after the positive sustain electrode driver applies the third voltage of the positive voltage to the sustain electrode, and
d) a fourth energy recovery part for a sustain electrode for applying energy corresponding to 0.5 times of the fourth voltage of the negative voltage to the sustain electrode by resonance while the first energy recovery part applies the energy and recovering energy corresponding to 0.5 times of the fourth voltage of the negative voltage by resonance after the negative sustain electrode driver applies the negative voltage to the fourth voltage to the sustain electrode.

14. The plasma display apparatus according to claim 13,
wherein the positive scan electrode driver further includes a fifth short prevention diode for blocking the second voltage to be applied to the ground when the second voltage is applied after the second energy recovery part for a scan electrode applies the energy,
wherein the negative scan electrode driver further includes a sixth diode for blocking the first voltage to be applied to the ground after the first energy recovery part for a scan electrode applied energy and the first voltage is applied,
wherein the positive sustain electrode driver further includes a seventh diode for blocking the fourth voltage to be applied to the ground when the fourth voltage is applied after the fourth energy scan electrode, and
wherein the negative sustain electrode driver further includes an eighth short prevention diode for blocking the third voltage to be applied to the ground when the third voltage is applied after the third energy recovery part applies.

15. The plasma display apparatus according to claim 13,
wherein the positive scan electrode driver further includes a fifth path selection part for isolating the scan electrode from the positive scan electrode driver while the negative scan electrode driver or the second energy recovery part for scan electrode operates,
wherein the negative scan electrode driver further includes a sixth path selection part for isolating the scan electrode from the negative scan electrode driver while the positive scan electrode driver or the first energy recovery part for scan electrode operates,
wherein the positive sustain electrode driver further includes a seventh path selection part for isolating the sustain electrode from the positive sustain electrode driver while the negative sustain electrode driver or the fourth energy recovery part for sustain electrode operates, and
wherein the negative sustain electrode driver further includes an eighth path selection part for isolating the sustain electrode from the negative sustain electrode driver while the positive sustain electrode driver or the third energy recovery part for sustain electrode operates.

16. A plasma display apparatus, comprising:
a plasma display panel including a scan electrode and a sustain electrode;
a scan electrode driver for alternately applying a first voltage with a positive value and a second voltage with a negative value to the scan electrode in a sustain period; and
a sustain electrode driver for applying a third voltage with a positive value to the sustain electrode in the sustain period while the scan electrode driver applies the second voltage with the negative value to the scan electrode and applying a fourth voltage with a negative value to the sustain electrode in the sustain period while the scan electrode driver applies the first voltage with the positive value to the scan electrode.

17. A driving method of a plasma display apparatus for driving a scan electrode and a sustain electrode in sustain period, comprising the steps of:
alternatively applying a first voltage with a positive value and a second voltage with a negative value to the scan electrode; and
alternatively applying a third voltage with a positive value and a fourth voltage with a negative value to the sustain electrode.

18. The driving method according to claim 17,
wherein the first voltage with the positive value is a positive voltage corresponding to n (0<n<1, n is a real number) times of a value obtained by adding the absolute value of the first voltage to the absolute value of the fourth voltage,
wherein the second voltage with the negative value is a negative voltage corresponding to (1-m) times (0<m<1, m is a real number) of a value obtained by adding the absolute value of the second voltage to the absolute value of the third voltage,
wherein the fourth voltage with the negative value is a negative voltage corresponding to (1-n) times of the value obtained by adding the absolute value of the first voltage to the absolute value of the fourth voltage, and
wherein the third voltage with the positive value is a positive voltage corresponding to m times of the value obtained by adding the absolute value of the third voltage to the absolute value of the second voltage.

19. The driving method according to claim 18,
wherein the first voltage with the positive value is a positive voltage corresponding to 0.5 times of a value obtained by adding the absolute value of the first voltage to the absolute value of the fourth voltage,
wherein the second voltage with the negative value is a negative voltage corresponding to 0.5 times of a value obtained by adding the absolute value of the second voltage to the absolute value of the third voltage,
wherein the fourth voltage with the negative value is a negative voltage corresponding to 0.5 times of the value obtained by adding the absolute value of the first voltage to the absolute value of the fourth voltage, and
wherein the third voltage with the positive value is a positive voltage corresponding to 0.5 times of the value obtained by adding the absolute value of the third voltage to the absolute value of the second voltage.

20. The driving method according to claim 17,
wherein energy corresponding to 0.5 times of the first voltage with a positive value is applied through the scan electrode, and energy corresponding to 0.5 times of the first voltage with the positive value is recovered through the scan electrode after the first voltage is applied to the scan electrode,
wherein energy corresponding to 0.5 times of the second voltage with a negative value is applied through the scan electrode, and energy corresponding to 0.5 times of the second voltage with the negative value is recovered through the scan electrode after the second voltage is applied to the scan electrode,
wherein energy corresponding to 0.5 times of the fourth voltage with a negative value through the sustain electrode, and energy corresponding to 0.5 times of the fourth voltage with the negative value through the sustain electrode after the fourth voltage is applied to the sustain electrode, and
wherein energy corresponding to 0.5 times of the third voltage with a positive value through the sustain electrode, and energy corresponding to 0.5 times of the third voltage with the negative value through the sustain electrode after the third voltage is applied to the sustain electrode.
